(19) United States
(12) Patent Application Publication
(10) Pub. No.: US 2026/0073250 A1
(43) Pub. Date: Mar. 12, 2026

(54) SYSTEM AND METHOD FOR HYBRID KNOWLEDGE GRAPH QUERY PROCESSING USING GENERIC SCHEMA MAPPING AND TEMPLATE-BASED QUERY RESOLUTION

(71) Applicant: Leidos, Inc., Reston, VA (US)

(72) Inventors: Jackson D. Scott, Huntsville, AL (US); Erin A. Smith Crabb, Haymarket, VA (US)

(73) Assignee: Leidos, Inc., Reston, VA (US)

(21) Appl. No.: 19/322,789

(22) Filed: Sep. 9, 2025

Related U.S. Application Data
(60) Provisional application No. 63/692,200, filed on Sep. 9, 2024.

(51) Int. Cl. G06N 5/022; G06F 16/334

(52) U.S. Cl. CPC G06N 5/022; G06F 16/3344

(57) ABSTRACT

A process and system for facilitating natural language interrogation of system engineering models is described. The process and system utilize multiple formatting translations of the original SysML model into a graph schema which can be queried by a user using LLM-backed Retrieval Augmented Generation (RAG).

### CROSS REFERENCE TO RELATED APPLICATIONS

The present application claims the benefit of priority to U.S. Provisional Patent Application No. 63/692,200 entitled SYSTEM AND METHOD FOR FACILITATING UNDERSTANDING OF SYSTEMS ENGINEERING WITH ARTIFICIAL INTELLIGENCE filed Sep. 9, 2024, which is incorporated herein by reference in its entirety.

### COMPUTER PROGRAM LISTING

The following Appendices hereto includes the following computer program listings which are incorporated herein by reference: APPENDIX A: “LEID0059_FUSE_AI Code.txt” created on Sep. 8, 2025, 43.8 MB; APPENDIX B: “LEID0059_AgentCode.txt” created on Sep. 7, 2025, 14.9 KB and APPENDIX C: “LEID0059_AgentCodeSpecific Example.txt” created on Sep. 7, 2025, 11.7 KB.

### BACKGROUND

### Field of Embodiments

Generally, the field of the embodiments is facilitating natural language queries of systems engineering models (SysML models).

### Description of Related Art

At the core of Model-Based Systems Engineering (MBSE) are system models which provide the structured representation of a system's functions, behavior and structure. Currently, processes for generating and assessing systems engineering models is done entirely manually by skilled practitioners and systems engineers. While standardized languages have been adopted across the many industries that rely on MBSE, the universe of individuals who understand these languages is limited. And there are no known tools for querying systems engineering models to ascertain model details.

Complex domain models like Systems Modeling Language (SysML) digital twins contain rich structural information that, when translated to knowledge graphs, create intricate node-relationship patterns. Traditional approaches either: require LLMs to dynamically discover and understand graph schemas before generating queries, leading to high computational costs and unreliable results, or use pure vector search without leveraging the inherent structural relationships, losing valuable semantic information. The fundamental problem is efficiently bridging natural language queries with the structured knowledge encoded in domain-specific graph schemas.

It would be highly beneficial to many industries, including, but not limited to the aerospace, defense, rail, automotive, and manufacturing industries to have a way to bridge understanding gap and allow for natural language prompted queries of system models.

### SUMMARY OF THE EMBODIMENTS

An embodiment includes a process for facilitating interrogation of system engineering models comprising: translating, by a processing system, a system engineering model representing a specific system in a first format into one or more Knowledge Graphs (KG) having a second format; and translating, by the processing system, the one or more KGs from the second format into a third format, wherein the third format is a graph schema; populating a graph database, by the processing system, with the graph schema representation of the system engineering model; receiving, by the processing system, a text query of the graph database by a user; retrieving, by the processing system, the graph schema from the graph database; passing, by the processing system, the user's text query and the response from the graph scheme to a first large language model (LLM); formulating, by the first LLM, a graph database query from the user's text query and the graph schema; querying the graph database, by the processing system, with the graph database query; receiving, by the processing system, a response to the graph database query from the graph database; passing, by the processing system, the user's text query and the response from the graph database to a second large language model (LLM); generating, by the second LLM, a text-based response to the user's text query; and providing, by the processing system, the text-based response to the user.

### BRIEF DESCRIPTION OF THE FIGURES

Example embodiments will become more fully understood from the detailed description given herein below and the accompanying drawings, wherein like elements are represented by like reference characters, which are given by way of illustration only and thus do not limit the exemplary embodiments herein.

FIG. 1 shows high-level schematic of an exemplary system engineering interrogation workflow (FUSE_AI) in accordance with embodiments herein.

FIGS. 2A, 2B, 2C, 2D, 2E, 2F and 2G are representative exemplary prior art graph schema used by the graph translation tool in accordance with embodiments herein.

FIGS. 3A and 3B are an exemplary SysML prior art snapshot (FIG. 3A) and the resulting KG from the graph translation tool (FIG. 3B) in accordance with embodiments herein.

### DETAILED DESCRIPTION

The embodiments are directed to a process for facilitating interrogation of system engineering models for facilitating understanding of systems engineering with artificial intelligence (reference herein as “FUSE-AI”). A computer-implemented system for querying knowledge graphs derived from structured domain models (such as SysML digital twin representations) using a hybrid approach that combines vector semantic search with pre-defined template queries, eliminating the need for real-time schema discovery while leveraging domain-specific structural knowledge. Through the translation of SysML models into Knowledge Graphs (KG), users gain access to a plethora of advanced artificial intelligence (AI) techniques leveraging the power of LLMs, including, but not limited to 1) graph (model) analysis, design, and improvement, and 2) retrieval augmented generation (RAG). This allows for both systems engineers and non-systems engineers (e.g., general users) to find information in, reference, and enhance the engineering model. The present embodiments synergize an LLM with a knowledge graph (KG) to perform Question-Answering (QA) over the graph model in natural language.

MBSE system models are generally modeled in an industry standardized language based on the Unified Modeling Language (UML). The objective of UML is to provide system architects, software engineers, and software developers with tools for analysis, design, and implementation of software-based systems as well as for modeling business and similar processes. The UML specification is maintained by the Object Management Group (OMG). The most recent release is Version 2.5.1 from 2017. Languages have been derived from the UML for specific applications. Such languages include, for example, Systems Modeling Language (SysML); UML eXchange Format (UXF); XML Metadata Interchange (XMI) and Executable UML (xUML). SysML is the primary language derived from UML for system engineering to address the specific needs of systems engineers working on complex, multi-disciplinary systems. SysML models are designed to be exchanged using the XMI standard.

Large language models (LLMs), such as ChatGPT and GPT4, are quickly gaining traction in the field of artificial intelligence, due to their emergent ability and generalizability. However, LLMs are fundamentally text-based models, which is limiting because most real-world data is best represented as a graph. Graphs are structured knowledge models which explicitly store rich information, such as a digitally engineered model created inside of existing programs such as MagicDraw. It is beneficial to unify LLMs with graph structures such that they may simultaneously leverage their unique advantages.

Large language models (LLMs) are advanced artificial intelligence systems designed to understand and generate human-like text based on vast natural language datasets. Utilizing deep learning techniques, particularly neural networks with billions of parameters, LLMs can process and produce coherent and contextually relevant language. Their architecture typically involves transformer models, which excel at capturing long-range dependencies in text. These models are trained on diverse corpora, enabling them to perform a wide range of language-related tasks, from translation to summarization, significantly advancing natural language processing.

Natural language input to LLMs is characterized by its sequential structure, where the meaning of each word or phrase depends on its context within a sentence or larger body of text. This sequential nature is crucial for understanding syntax, grammar, and the nuances of human communication. LLMs leverage this structure to predict and generate coherent and contextually appropriate text. Additionally, natural language input contains implicit knowledge, including cultural references, idiomatic expressions, and domain-specific terminology, which LLMs learn to recognize and interpret through extensive training. By capturing these subtleties, LLMs can perform complex tasks such as summarizing information, answering questions, and engaging in meaningful dialogue.

A knowledge graph (“KG”) is a structured representation of information, where entities are nodes, and relationships between them are edges, forming a graph. This non-Euclidean data structure captures complex relationships and hierarchies, allowing for efficient querying and reasoning about the data. KGs are often used to integrate diverse datasets, enabling the discovery of new insights by linking related information across different domains. They employ ontologies and schemas to maintain consistency and semantic integrity, ensuring accurate representation of knowledge. Common applications of KGs include search engines, recommendation systems, and natural language understanding tasks, where they enhance the contextual understanding of data.

KG triples are the fundamental building blocks used to construct a KG, each triple Comprising a subject, predicate, and object to represent a discrete piece of information. These triples interconnect to form a graph structure, where subjects and objects become nodes, and predicates define the edges, illustrating relationships between nodes. By aggregating numerous triples, a KG can encapsulate complex networks of entities and their interrelations, enabling rich, semantically meaningful representations of data. Algorithms and ontologies are employed to organize and validate these triples, ensuring consistency and coherence within the graph. This structured approach facilitates efficient data querying, integration, and reasoning, supporting applications such as semantic search, recommendation systems, and data analytics.

KGs exhibit an explicit structural nature, where information is represented through clearly defined entities (nodes) and relationships (edges), allowing for straightforward querying and analysis. In contrast, natural language text has an implicit structural nature, with meaning and context embedded within the sequential flow of words. KGs provide explicit connections and hierarchies, making the relationships between data points immediately apparent. Conversely, natural language text relies on syntax, grammar, and context, necessitating advanced natural language processing techniques to uncover underlying relationships. This fundamental difference impacts how each is processed and utilized, with KGs excelling in structured data applications and natural language text being more versatile in capturing nuanced human communication.

LLMs lack the inherent architecture to directly parse and understand a graph-based structure, as their training and operational paradigms are optimized for sequential text data. To leverage KGs, LLMs require intermediate steps to convert graph data into a text format they can process, or they need to be integrated with specialized graph processing techniques (our approach).

Retrieval Augmented Generation (RAG) is a sophisticated approach in natural language processing that combines the strengths of information retrieval and text generation models. In this method, a retrieval component first searches a large corpus or database to find relevant documents or passages related to a given query. The retrieved information is then fed into a generative model, typically a LLM, which synthesizes this information to produce coherent and contextually relevant responses. This hybrid approach enhances the LLM's ability to generate accurate and informative text, as it grounds the generative process in factual data from the retrieval step. RAG is particularly effective in scenarios requiring up-to-date and precise information, such as question answering, customer support, and knowledge-based dialogues.

RAG over a KG integrates the capabilities of information retrieval and text generation by leveraging structured data stored within a KG. The retrieval component queries the KG to extract relevant information, which encapsulate specific entities and/or their relationships. These retrieved query results provide factual and contextual grounding for the generative model, which synthesizes this structured information into coherent and contextually appropriate responses. Utilizing a KG enhances the precision and reliability of the generated content, as it relies on explicitly defined relationships and entities. This approach is particularly advantageous for tasks requiring high accuracy and context-awareness, such as complex question answering and detailed knowledge-based dialogues.

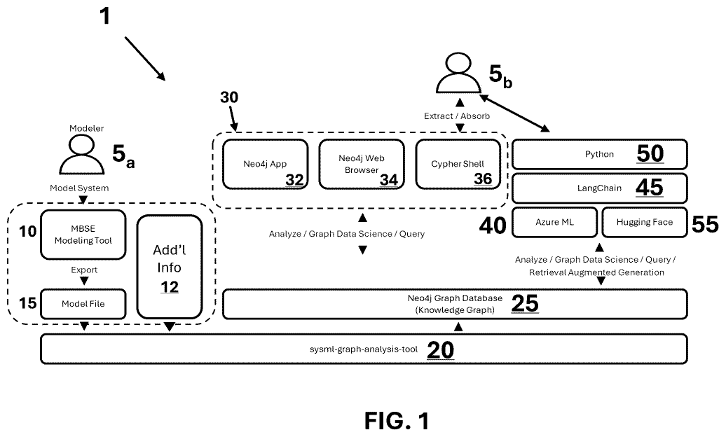

FIG. 1 provides a high level schematic of implementing system and process flow 1. Initially, a SysML model is developed by a modeler 5ₐ via a modeling system which includes Model Based Systems Engineering (MBSE) software tools(s) 10 and may also include additional information sources 12 related to the SysML model development. MBSE tools 10 are known to those skilled in the art and enable systems engineers to create SysML models of complex systems. A non-limiting example of an MBSE tool is known in the art as Cameo, which is built on the MagicDraw unified modeling language (UML) platform and is an industry recognized tool for modeling MBSE systems. These SysML models are used to define system requirements and architecture design. The SysML models are used in simulations and for analysis. It is to be understood that while the present description references SysML, the process described herein is not so limited. Other system modeling language models may be used, including other languages derived from the unified modeling language (UML) models.

Next, a SysML model file 15 that a user wishes to investigate is exported to and ingest by a SysML Graph translation tool (or “layer”) 20 which translates the SysML model 15 into a SysML model knowledge graph (KG) 25 for storage in a KG graph database like Neo4j or a Graph Neural Network library (e.g., PyTorch Geometric). Exemplary SysML Graph translation tools extract the internal structure of the SysML model, including its elements and their hierarchical component relationships, interfaces, and requirements (e.g., part properties, containment, allocations) from the imported SysML model file 15 and produce a flexible, interconnected knowledge graph. By way of example, the following SysML model diagram types are used by the translation tool: Block Definition Diagrams (“BDD”); Internal Block Diagrams (“IBD”); Activity Diagrams; State Machines; Use Case Diagrams; and Requirement Diagrams. It is to be understood that while the present description uses the Neo4j graph database, the process described herein is not so limited.

SysML Graph translation tool 20 applies a generic schema translation layer that maps domain-specific constructs to standardized graph patterns (nodes with labels like: SYSML, relationships like :IS_PART_OF, :IS_OF_TYPE). The constructed schema preserves domain semantics while creating a consistent queryable structure and maintains bidirectional traceability between original domain elements and graph representations.

A knowledge graph (KG) is a structured representation of information, where entities are represented in a symbolic and structured form consisting of entities as nodes and relationships as edges, forming a graph composed of “triples.” An example Triple: Subject: “Albert Einstein”->Predicate: “was born in”->Object: “Ulm”. By importing SysML models as KG, users can leverage robust querying and analysis capabilities to explore, analyze, and improve system architectures in detail.

In an alternative embodiment, additional information sources 12 are also transferred to the SysML Graph translation tool 20 and/or stored in the database. These can include, but are not limited to: chats from the public channels of a Slack instance; information stored in classical file storage systems that is accessible to the tool and can be parsed by, e.g. Apache Tika, such as Microsoft Office documents, emails or pdf documents; groups, repositories, commits, merge requests, files, branches and users from a GitLab instance. The SysML, GitLab and Slack may be correlated according to predefined schemata as described in the SysML and Development Information Graph Analysis Tool, README.md in the gitlab.lrz repository (created on Jan. 13, 2022) (hereafter the “LRZ SysML Graph Analysis Tool documentation”).

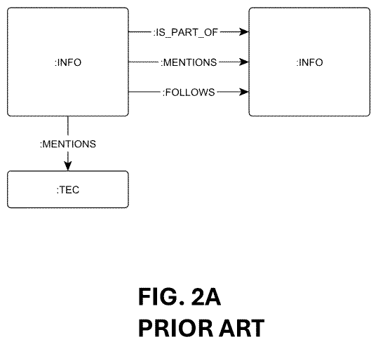

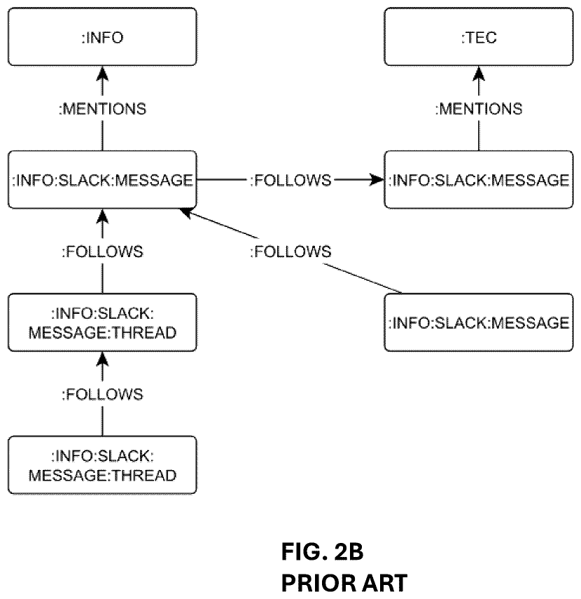

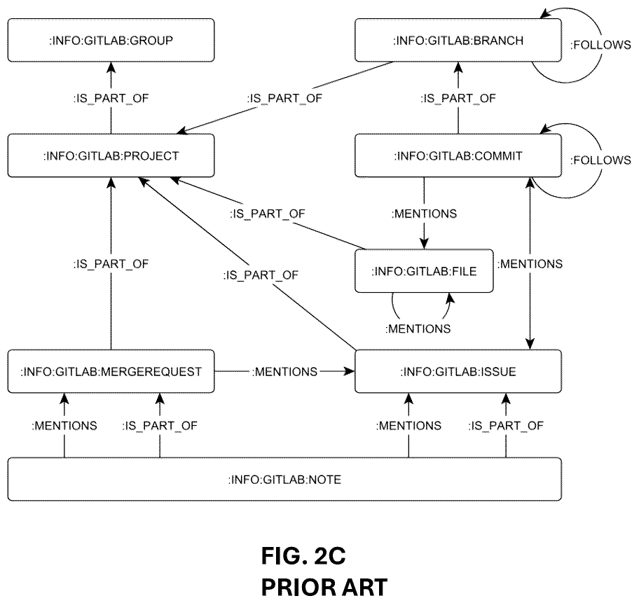

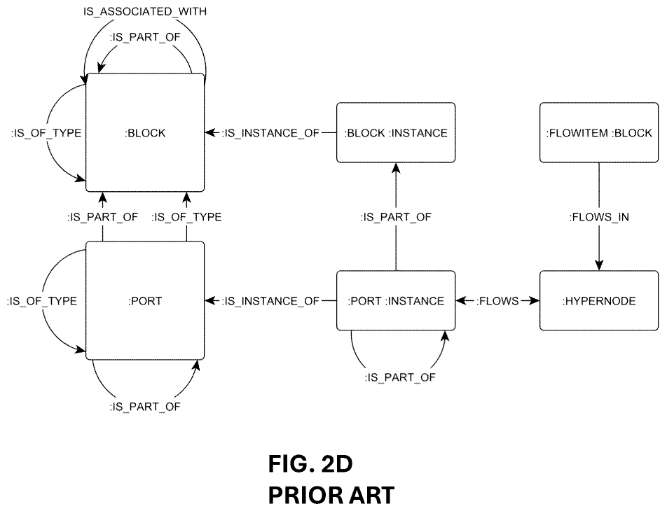

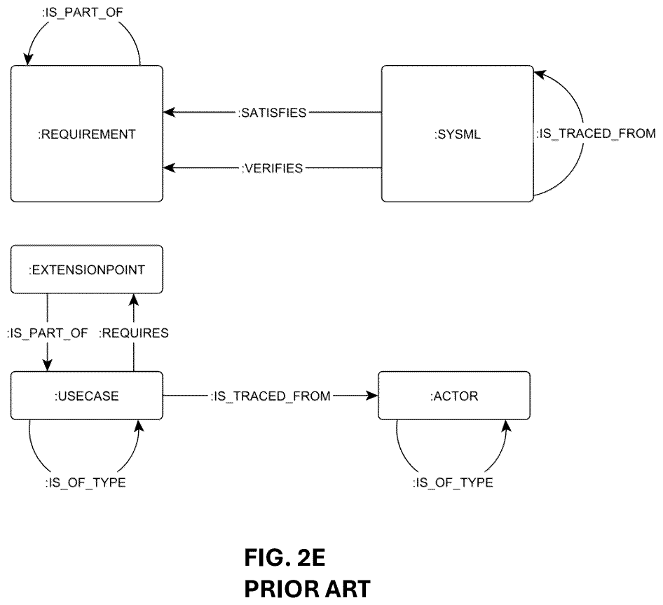

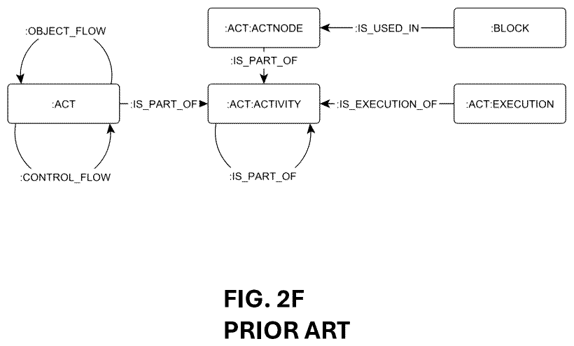

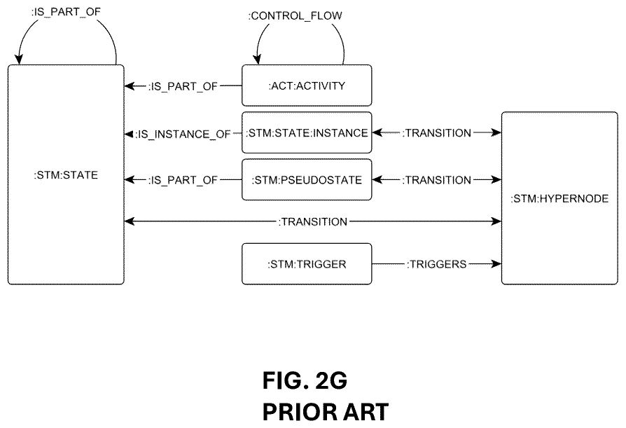

FIGS. 2A, 2B, 2C, 2D, 2E, 2F, 2G are representative exemplary prior art graph schema used by the graph translation tool 20 to represent the additional information 12 and the internal structure of the model file 15 and described in the LRZ SysML Graph Analysis Tool documentation and in Schummer et al., “An Approach for System Analysis with MBSE and Graph Data Engineering,” Data-Centric Engineering (2022), 1-37, which are incorporated herein by reference in their entireties. FIG. 2A represents a general (or generic) information schema for translating additional information 12, while FIGS. 2B and 2C provided more particular schema for translating imported Slack chats and Github, specifically groups, repositories, commits, merge requests, files, branches and users from GitLab instances. FIGS. 2D to 2G are schema for representing SysML BDD, IBD, Activity Diagrams, State Machines, Use Case Diagrams and Requirement Diagrams. FIG. 2D is an exemplary schema used for translating block properties of the imported SysML model. FIG. 2E is an exemplary schema used for translating requirements of the imported SysML model. FIG. 2F is an exemplary schema used for translating activities of the imported SysML model. FIG. 2G is an exemplary schema used for translating state machine (STM) details of the imported SysML model.

The translation of the SysML model to a KG format with the additional processing by the SysML Graph translation tool 20 is a critical step in the process described herein for implementation of RAG to successfully query SysML models. While it is possible to directly import a SysML model file (in .xml) 15 into the Neoj4 database 25, where the browser 34 creates a KG directly from the .xml without additional processing, the underlying desired data representation is not preserved in the resulting graph.

Once in the SysML model KG format, various tools may be used/accessed by a user 5_{b} to query, detect, retrieve, converse, and analyze relevant information from the SysML model KG 25. For example, the Neo4j suite 30 provides access, query and analysis capabilities through the app 32, browser 34 and cypher shell 36 components which use graph query language, Cypher. Open-source Large Language Models (LLMs) 40 may be accessed through the Neo4j suite 30 to query the SysML model KG 25. To facilitate this access and queries, LLM-applications development frameworks such as LangChain 45, which support Python code language 50, are used, along with other model-sharing platforms and libraries such as Hugging Face 55. These tools enable users to implement graph analysis techniques, graph machine learning, graph exploration, etc. Tools, like LangChain, enable Retrieval-Augmented Generation (RAG) or Agentic RAG to supplement queries and improve the conversation with the SysML model KG 25.

The system 1 creates a semantic search capability over the structured graph by first extracting comprehensive textual representations from each graph node, including names, types, requirements, descriptions, and domain-specific identifiers. Next, the system generates high-dimensional vector embeddings (e.g., 2,034 nodes with 1536-dimensional embeddings) for enhanced textual content using advanced large language models (LLMs) and creates vector indices enabling semantic similarity search across graph nodes without requiring structural knowledge. The embeddings and enhanced text are stored directly within graph nodes for efficient retrieval.

For implementation in the preferred embodiment, the Neo4j suite offers native connection with key LLM/GenAI libraries, such as LangChain which facilitates the transformation of natural language into Cypher queries allowing for full use of all structural information. LangChain additionally allows Neo4j nodes to be vectorized and embedded within a retrieval space that can allow for semantic search. LLM's have been trained to interpret natural language inputs and translate them into Cypher queries for interacting with Neo4j databases, enabling users to retrieve and manipulate graph data without needing in-depth knowledge of the query language. A LLM-generated cypher query can be used as part of the retrieval component in a RAG system. The query returns can then be reasoned over by another LLM to synthesize a natural language response to the original input. In essence, users may use natural language to “talk to” a SysML model hosted in Neo4j following this paradigm.

In a preferred embodiment, the system 1 implements a template-based query architecture. Rather than generating queries dynamically, the system leverages pre-built query templates that exploit known schema patterns. A preferred system 1 maintains a library of domain-optimized query templates corresponding to common information needs. Each template encodes specific graph traversal patterns using the standardized schema (e.g., finding all components within a system hierarchy, retrieving interface specifications). Templates are parameterized to accept entity identifiers and constraint values extracted from natural language queries. Query templates are pre-validated and performance-optimized for the target schema structure.

Accordingly, the system 1 supports a hybrid query resolution process. In a first phase, sematic entity discovery, the system receives natural language queries about the domain mode, performs vector similarity search against embedded graph nodes to identify semantically relevant entities, ranks candidate nodes by relevance without requiring structural graph knowledge and creates “reasoning paths” which are collections of potentially relevant nodes that serve as query starting points. In a second phase, the system performs intent classification and template selection from the pre-validated and performance optimized query templates. This phase includes: analyzing the natural language query to determine information intent (e.g., “find components”, “get specifications”, “trace relationships”), mapping query intent to appropriate pre-defined template queries using LLM-based classification and leveraging domain context descriptions to improve intent recognition accuracy. Finally, in the final phase, the hybrid query resolution process performs parameter extraction and query execution, including: extracting specific entity references from reasoning paths to populate template parameters, using LLM to map natural language entity mentions to concrete graph node identifiers, executes parameterized template queries against the knowledge graph and combining structured query results with semantic context for comprehensive response generation.

Finally, the system generates a domain-aware response including: integrating structured query results with vector-retrieved semantic context; using domain-specific knowledge (digital twin descriptions, component hierarchies) to generate contextually appropriate responses and maintaining traceability to original domain model elements for verification and deeper exploration.

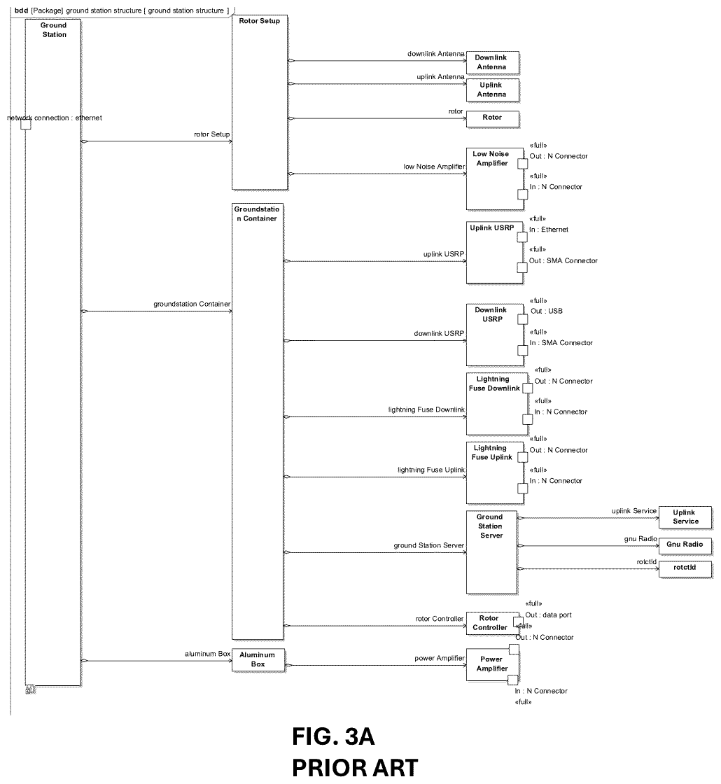

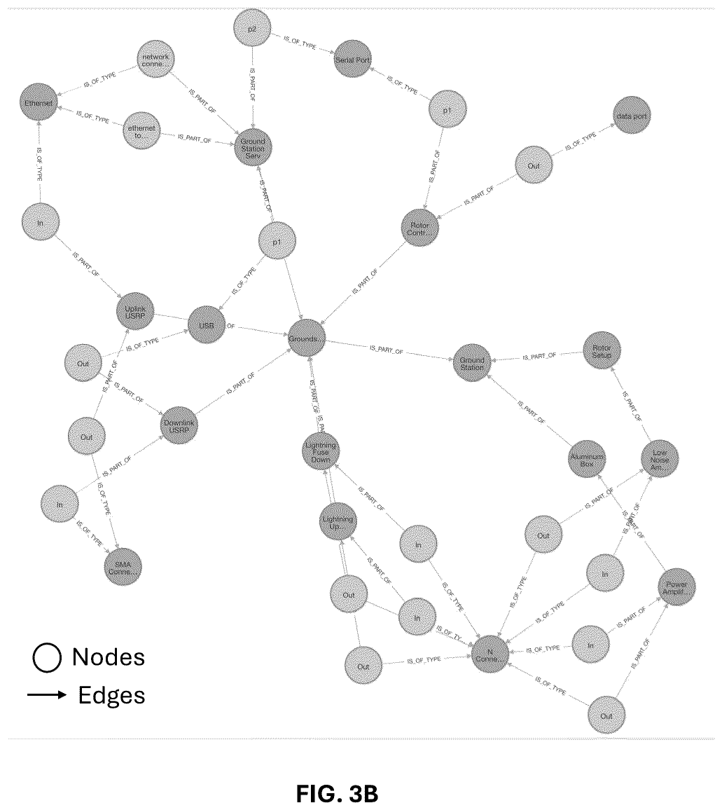

An applied example of the process from SysML model through a user query and generated response is described below and with reference to FIGS. 3A and 3B and code APPENDIX B. FIG. 3A is an exemplary snapshot SysML model generated by the prior art Cameo modeling product. In this very specific example, this snapshot is a BDD of a ground station structure. Using present system 1, the SysML graph translation tool 20 translates the snapshot of FIG. 3A into the KG schema in FIG. 3B in accordance with following schema requirements:

Node properties:
BLOCK {embedded_text: STRING, embedding: LIST, id: STRING, name: STRING,
type: STRING}
SYSML {embedding: LIST, embedded_text: STRING, id: STRING, name: STRING,
type: STRING, isConjugated: STRING, port_type_id: STRING, port_id: STRING,
port_instance_id: STRING, block_instance_id: STRING, end1id: STRING, end1role:
STRING, end2id: STRING, end2role: STRING, end1partWithPort: STRING, pins:
STRING, nodetype: STRING, title: STRING, Requirement_ID_in_MagicDraw:
STRING, Text: STRING, TracedTo: STRING}
TEC {embedded_text: STRING, embedding: LIST, id: STRING, name: STRING, type:
STRING, isConjugated: STRING, port_type_id: STRING, port_id: STRING,
port_instance_id: STRING, block_instance_id: STRING, end1id: STRING, end1role:
STRING, end2id: STRING, end2role: STRING, end1partWithPort: STRING, pins:
STRING, nodetype: STRING, title: STRING, Requirement_ID_in_MagicDraw:
STRING, Text: STRING, TracedTo: STRING}
INSTANCE {type: STRING, embedding: LIST, embedded_text: STRING, id: STRING,
name: STRING, port_id: STRING, port_instance_id: STRING, block_instance_id:
STRING}
PORT {isConjugated: STRING, embedding: LIST, embedded_text: STRING, id:
STRING, name: STRING, port_type_id: STRING, port_id: STRING,
port_instance_id: STRING, block_instance_id: STRING}
FULLPORT {isConjugated: STRING, embedding: LIST, embedded_text: STRING, id:
STRING, name: STRING, port_type_id: STRING}
PROXY {embedded_text: STRING, id: STRING, name: STRING, isConjugated:
STRING, embedding: LIST, port_type_id: STRING}
HYPERNODE {id: STRING, embedding: LIST, embedded_text: STRING, end1id:
STRING, end1role: STRING, end2id: STRING, end2role: STRING, end1partWithPort:
STRING}
FLOWITEM {embedded_text: STRING, embedding: LIST, id: STRING, name:
STRING}
ACT {embedded_text: STRING, pins: STRING, id: STRING, name: STRING,
embedding: LIST, type: STRING, nodetype: STRING}
ACTIVITY {embedded_text: STRING, pins: STRING, id: STRING, name: STRING,
embedding: LIST}
ACTNODE {embedded_text: STRING, name: STRING, type: STRING, embedding:
LIST, nodetype: STRING, id: STRING}
REQUIREMENT {title: STRING, embedding: LIST, embedded_text: STRING,
Requirement_ID_in_MagicDraw: STRING, id: STRING, Text: STRING, TracedTo:
STRING}
USECASE {id: STRING, name: STRING, embedding: LIST, embedded_text: STRING}
ACTOR {embedded_text: STRING, id: STRING, name: STRING, embedding: LIST}
Relationship properties:
IS_PART_OF {id: STRING, type: STRING}
FLOWS_IN {id: STRING}
CONTROL_FLOW {id: STRING}
IS_TRACED_FROM {sysmltype: STRING}
The relationships:
(:BLOCK)-[:FLOWS_IN]−>(:SYSML)
(:BLOCK)-[:FLOWS_IN]−>(:TEC)
(:BLOCK)-[:FLOWS_IN]−>(:HYPERNODE)
(:BLOCK)-[:IS_PART_OF]−>(:BLOCK)
(:BLOCK)-[:IS_PART_OF]−>(:SYSML)
(:BLOCK)-[:IS_PART_OF]−>(:TEC)
(:BLOCK)-[:IS_PART_OF]−>(:FLOWITEM)
(:BLOCK)-[:SATISFIES]−>(:SYSML)
(:BLOCK)-[:SATISFIES]−>(:TEC)
(:BLOCK)-[:SATISFIES]−>(:REQUIREMENT)
(:BLOCK)-[:IS_OF_TYPE]−>(:BLOCK)
(:BLOCK)-[:IS_OF_TYPE]−>(:SYSML)
(:BLOCK)-[:IS_OF_TYPE]−>(:TEC)
(:BLOCK)-[:IS_OF_TYPE]−>(:FLOWITEM)
(:BLOCK)-[:FLOWS]−>(:SYSML)
(:BLOCK)-[:FLOWS]−>(:TEC)
(:BLOCK)-[:FLOWS]−>(:INSTANCE)
(:BLOCK)-[:FLOWS]−>(:PORT)
(:BLOCK)-[:IS_INSTANCE_OF]−>(:BLOCK)
(:BLOCK)-[:IS_INSTANCE_OF]−>(:SYSML)
(:BLOCK)-[:IS_INSTANCE_OF]−>(:TEC)
(:SYSML)-[:FLOWS_IN]−>(:SYSML)
(:SYSML)-[:FLOWS_IN]−>(:TEC)
(:SYSML)-[:FLOWS_IN]−>(:HYPERNODE)
(:SYSML)-[:IS_PART_OF]−>(:BLOCK)
(:SYSML)-[:IS_PART_OF]−>(:SYSML)
(:SYSML)-[:IS_PART_OF]−>(:TEC)
(:SYSML)-[:IS_PART_OF]−>(:FLOWITEM)
(:SYSML)-[:IS_PART_OF]−>(:PORT)
(:SYSML)-[:IS_PART_OF]−>(:FULLPORT)
(:SYSML)-[:IS_PART_OF]−>(:INSTANCE)
(:SYSML)-[:IS_PART_OF]−>(:ACT)
(:SYSML)-[:IS_PART_OF]−>(:ACTIVITY)
(:SYSML)-[:IS_PART_OF]−>(:REQUIREMENT)
(:SYSML)-[:IS_OF_TYPE]−>(:BLOCK)
(:SYSML)-[:IS_OF_TYPE]−>(:SYSML)
(:SYSML)-[:IS_OF_TYPE]−>(:TEC)
(:SYSML)-[:IS_OF_TYPE]−>(:FLOWITEM)
(:SYSML)-[:SATISFIES]−>(:SYSML)
(:SYSML)-[:SATISFIES]−>(:TEC)
(:SYSML)-[:SATISFIES]−>(:REQUIREMENT)
(:SYSML)-[:FLOWS]−>(:SYSML)
(:SYSML)-[:FLOWS]−>(:TEC)
(:SYSML)-[:FLOWS]−>(:INSTANCE)
(:SYSML)-[:FLOWS]−>(:PORT)
(:SYSML)-[:FLOWS]−>(:BLOCK)
(:SYSML)-[:FLOWS]−>(:HYPERNODE)
(:SYSML)-[:IS_INSTANCE_OF]−>(:BLOCK)
(:SYSML)-[:IS_INSTANCE_OF]−>(:SYSML)
(:SYSML)-[:IS_INSTANCE_OF]−>(:TEC)
(:SYSML)-[:IS_INSTANCE_OF]−>(:PORT)
(:SYSML)-[:IS_INSTANCE_OF]−>(:FULLPORT)
(:SYSML)-[:IS_INSTANCE_OF]−>(:PROXY)
(:SYSML)-[:CONTROL_FLOW]−>(:SYSML)
(:SYSML)-[:CONTROL_FLOW]−>(:TEC)
(:SYSML)-[:CONTROL_FLOW]−>(:ACT)
(:SYSML)-[:CONTROL_FLOW]−>(:ACTIVITY)
(:SYSML)-[:IS_TRACED_FROM]−>(:SYSML)
(:SYSML)-[:IS_TRACED_FROM]−>(:TEC)
(:SYSML)-[:IS_TRACED_FROM]−>(:REQUIREMENT)
(:SYSML)-[:IS_TRACED_FROM]−>(:USECASE)
(:SYSML)-[:IS_TRACED_FROM]−>(:ACTOR)
(:TEC)-[:FLOWS_IN]−>(:SYSML)
(:TEC)-[:FLOWS_IN]−>(:TEC)
(:TEC)-[:FLOWS_IN]−>(:HYPERNODE)
(:TEC)-[:IS_PART_OF]−>(:BLOCK)
(:TEC)-[:IS_PART_OF]−>(:SYSML)
(:TEC)-[:IS_PART_OF]−>(:TEC)
(:TEC)-[:IS_PART_OF]−>(:FLOWITEM)
(:TEC)-[:IS_PART_OF]−>(:PORT)
(:TEC)-[:IS_PART_OF]−>(:FULLPORT)
(:TEC)-[:IS_PART_OF]−>(:INSTANCE)
(:TEC)-[:IS_PART_OF]−>(:ACT)
(:TEC)-[:IS_PART_OF]−>(:ACTIVITY)
(:TEC)-[:IS_PART_OF]−>(:REQUIREMENT)
(:TEC)-[:IS_OF_TYPE]−>(:BLOCK)
(:TEC)-[:IS_OF_TYPE]−>(:SYSML)
(:TEC)-[:IS_OF_TYPE]−>(:TEC)
(:TEC)-[:IS_OF_TYPE]−>(:FLOWITEM)
(:TEC)-[:SATISFIES]−>(:SYSML)
(:TEC)-[:SATISFIES]−>(:TEC)
(:TEC)-[:SATISFIES]−>(:REQUIREMENT)
(:TEC)-[:FLOWS]−>(:SYSML)
(:TEC)-[:FLOWS]−>(:TEC)
(:TEC)-[:FLOWS]−>(:INSTANCE)
(:TEC)-[:FLOWS]−>(:PORT)
(:TEC)-[:FLOWS]−>(:BLOCK)
(:TEC)-[:FLOWS]−>(:HYPERNODE)
(:TEC)-[:IS_INSTANCE_OF]−>(:BLOCK)
(:TEC)-[:IS_INSTANCE_OF]−>(:SYSML)
(:TEC)-[:IS_INSTANCE_OF]−>(:TEC)
(:TEC)-[:IS_INSTANCE_OF]−>(:PORT)
(:TEC)-[:IS_INSTANCE_OF]−>(:FULLPORT)
(:TEC)-[:IS_INSTANCE_OF]−>(:PROXY)
(:TEC)-[:CONTROL_FLOW]−>(:SYSML)
(:TEC)-[:CONTROL_FLOW]−>(:TEC)
(:TEC)-[:CONTROL_FLOW]−>(:ACT)
(:TEC)-[:CONTROL_FLOW]−>(:ACTIVITY)
(:TEC)-[:IS_TRACED_FROM]−>(:SYSML)
(:TEC)-[:IS_TRACED_FROM]−>(:TEC)
(:TEC)-[:IS_TRACED_FROM]−>(:REQUIREMENT)
(:TEC)-[:IS_TRACED_FROM]−>(:USECASE)
(:TEC)-[:IS_TRACED_FROM]−>(:ACTOR)
(:INSTANCE)-[:FLOWS]−>(:SYSML)
(:INSTANCE)-[:FLOWS]−>(:TEC)
(:INSTANCE)-[:FLOWS]−>(:INSTANCE)
(:INSTANCE)-[:FLOWS]−>(:PORT)
(:INSTANCE)-[:FLOWS]−>(:HYPERNODE)
(:INSTANCE)-[:FLOWS]−>(:BLOCK)
(:INSTANCE)-[:IS_INSTANCE_OF]−>(:BLOCK)
(:INSTANCE)-[:IS_INSTANCE_OF]−>(:SYSML)
(:INSTANCE)-[:IS_INSTANCE_OF]−>(:TEC)
(:INSTANCE)-[:IS_INSTANCE_OF]−>(:PORT)
(:INSTANCE)-[:IS_INSTANCE_OF]−>(:FULLPORT)
(:INSTANCE)-[:IS_INSTANCE_OF]−>(:PROXY)
(:INSTANCE)-[:IS_PART_OF]−>(:BLOCK)
(:INSTANCE)-[:IS_PART_OF]−>(:SYSML)
(:INSTANCE)-[:IS_PART_OF]−>(:TEC)
(:INSTANCE)-[:IS_PART_OF]−>(:INSTANCE)
(:INSTANCE)-[:IS_PART_OF]−>(:PORT)
(:PORT)-[:SATISFIES]−>(:SYSML)
(:PORT)-[:SATISFIES]−>(:TEC)
(:PORT)-[:SATISFIES]−>(:REQUIREMENT)
(:PORT)-[:IS_PART_OF]−>(:BLOCK)
(:PORT)-[:IS_PART_OF]−>(:SYSML)
(:PORT)-[:IS_PART_OF]−>(:TEC)
(:PORT)-[:IS_PART_OF]−>(:PORT)
(:PORT)-[:IS_PART_OF]−>(:FULLPORT)
(:PORT)-[:IS_PART_OF]−>(:INSTANCE)
(:PORT)-[:IS_OF_TYPE]−>(:BLOCK)
(:PORT)-[:IS_OF_TYPE]−>(:SYSML)
(:PORT)-[:IS_OF_TYPE]−>(:TEC)
(:PORT)-[:FLOWS]−>(:SYSML)
(:PORT)-[:FLOWS]−>(:TEC)
(:PORT)-[:FLOWS]−>(:HYPERNODE)
(:PORT)-[:FLOWS]−>(:BLOCK)
(:PORT)-[:FLOWS]−>(:INSTANCE)
(:PORT)-[:IS_INSTANCE_OF]−>(:SYSML)
(:PORT)-[:IS_INSTANCE_OF]−>(:TEC)
(:PORT)-[:IS_INSTANCE_OF]−>(:PORT)
(:PORT)-[:IS_INSTANCE_OF]−>(:FULLPORT)
(:PORT)-[:IS_INSTANCE_OF]−>(:PROXY)
(:FULLPORT)-[:SATISFIES]−>(:SYSML)
(:FULLPORT)-[:SATISFIES]−>(:TEC)
(:FULLPORT)-[:SATISFIES]−>(:REQUIREMENT)
(:FULLPORT)-[:IS_PART_OF]−>(:BLOCK)
(:FULLPORT)-[:IS_PART_OF]−>(:SYSML)
(:FULLPORT)-[:IS_PART_OF]−>(:TEC)
(:FULLPORT)-[:IS_OF_TYPE]−>(:BLOCK)
(:FULLPORT)-[:IS_OF_TYPE]−>(:SYSML)
(:FULLPORT)-[:IS_OF_TYPE]−>(:TEC)
(:PROXY)-[:IS_PART_OF]−>(:BLOCK)
(:PROXY)-[:IS_PART_OF]−>(:SYSML)
(:PROXY)-[:IS_PART_OF]−>(:TEC)
(:PROXY)-[:IS_PART_OF]−>(:PORT)
(:PROXY)-[:IS_PART_OF]−>(:FULLPORT)
(:PROXY)-[:IS_OF_TYPE]−>(:BLOCK)
(:PROXY)-[:IS_OF_TYPE]−>(:SYSML)
(:PROXY)-[:IS_OF_TYPE]−>(:TEC)
(:HYPERNODE)-[:FLOWS]−>(:SYSML)
(:HYPERNODE)-[:FLOWS]−>(:TEC)
(:HYPERNODE)-[:FLOWS]−>(:INSTANCE)
(:HYPERNODE)-[:FLOWS]−>(:PORT)
(:FLOWITEM)-[:FLOWS_IN]−>(:SYSML)
(:FLOWITEM)-[:FLOWS_IN]−>(:TEC)
(:FLOWITEM)-[:FLOWS_IN]−>(:HYPERNODE)
(:FLOWITEM)-[:IS_PART_OF]−>(:BLOCK)
(:FLOWITEM)-[:IS_PART_OF]−>(:SYSML)
(:FLOWITEM)-[:IS_PART_OF]−>(:TEC)
(:FLOWITEM)-[:IS_PART_OF]−>(:FLOWITEM)
(:FLOWITEM)-[:IS_PART_OF]−>(:BLOCK)
(:FLOWITEM)-[:IS_OF_TYPE]−>(:SYSML)
(:FLOWITEM)-[:IS_OF_TYPE]−>(:TEC)
(:FLOWITEM)-[:IS_OF_TYPE]−>(:FLOWITEM)
(:ACT)-[:CONTROL_FLOW]−>(:SYSML)
(:ACT)-[:CONTROL_FLOW]−>(:TEC)
(:ACT)-[:CONTROL_FLOW]−>(:ACT)
(:ACT)-[:CONTROL_FLOW]−>(:ACTIVITY)
(:ACT)-[:IS_PART_OF]−>(:SYSML)
(:ACT)-[:IS_PART_OF]−>(:TEC)
(:ACT)-[:IS_PART_OF]−>(:ACT)
(:ACT)-[:IS_PART_OF]−>(:ACTIVITY)
(:ACT)-[:VERIFIES]−>(:SYSML)
(:ACT)-[:VERIFIES]−>(:TEC)
(:ACT)-[:VERIFIES]−>(:REQUIREMENT)
(:ACTIVITY)-[:CONTROL_FLOW]−>(:SYSML)
(:ACTIVITY)-[:CONTROL_FLOW]−>(:TEC)
(:ACTIVITY)-[:CONTROL_FLOW]−>(:ACT)
(:ACTIVITY)-[:CONTROL_FLOW]−>(:ACTIVITY)
(:ACTIVITY)-[:IS_PART_OF]−>(:SYSML)
(:ACTIVITY)-[:IS_PART_OF]−>(:TEC)
(:ACTIVITY)-[:IS_PART_OF]−>(:ACT)
(:ACTIVITY)-[:IS_PART_OF]−>(:ACTIVITY)
(:ACTIVITY)-[:VERIFIES]−>(:SYSML)
(:ACTIVITY)-[:VERIFIES]−>(:TEC)
(:ACTIVITY)-[:VERIFIES]−>(:REQUIREMENT)
(:ACTNODE)-[:CONTROL_FLOW]−>(:SYSML)
(:ACTNODE)-[:CONTROL_FLOW]−>(:TEC)
(:ACTNODE)-[:CONTROL_FLOW]−>(:ACT)
(:ACTNODE)-[:CONTROL_FLOW]−>(:ACTIVITY)
(:ACTNODE)-[:IS_PART_OF]−>(:SYSML)
(:ACTNODE)-[:IS_PART_OF]−>(:TEC)
(:ACTNODE)-[:IS_PART_OF]−>(:ACT)
(:ACTNODE)-[:IS_PART_OF]−>(:ACTIVITY)
(:REQUIREMENT)-[:IS_TRACED_FROM]−>(:SYSML)
(:REQUIREMENT)-[:IS_TRACED_FROM]−>(:TEC)
(:REQUIREMENT)-[:IS_TRACED_FROM]−>(:REQUIREMENT)
(:REQUIREMENT)-[:IS_TRACED_FROM]−>(:USECASE)
(:REQUIREMENT)-[:IS_PART_OF]−>(:SYSML)
(:REQUIREMENT)-[:IS_PART_OF]−>(:TEC)
(:REQUIREMENT)-[:IS_PART_OF]−>(:REQUIREMENT)
(:USECASE)-[:IS_TRACED_FROM]−>(:SYSML)
(:USECASE)-[:IS_TRACED_FROM]−>(:TEC)
(:USECASE)-[:IS_TRACED_FROM]−>(:ACTOR)

Given that the schema is generic, one-time context prompt is provided to the system by a user so the system knows what the context of the KG is a-priori. For example, with respect to the domain of the snapshot in FIGS. 3A and 3B, prior to attempting to querying the snapshot KG of FIG. 3B, the user might provide the following:

The MOVE-II (Munich Orbital Verification Experiment II) satellite is a CubeSat developed by students at the Technical University of Munich, designed to test and validate satellite technologies in low Earth orbit. Launched in December 2018, its mission focused on demonstrating systems like energy-efficient communication and power management. It also serves as an educational platform, allowing students to gain hands-on experience in satellite design, construction, and operation. The model encompasses the satellite, ground station, and operations systems and shows the data paths of all telemetry the spacecraft provides as well as all power paths within the spacecraft. The spacecraft itself consists of multiple subsystems:
Attitude Determination and Control System, controlling the spacecraft's attitude relative to the Earth and Sun
Communications (consisting of S-Band and UHF/VHF Transceiver), which provides contact to the ground
Command and Data Handling, which handles all telemetry, interprets communications, and controls the state of the satellite.
Electrical Power System, containing the spacecraft's batteries and power converters and controlling the maximum power point
Solar Cell Payload, solar cells that shall be measured against degradation over time in the space environment.
Structure and Mechanisms, providing structural integrity and deploying the antennas and solar array.

Next, the system receives a natural language query from a user 5_{b} as follows: “What are all the types of ports in the Ground Station?” This query initiates traversal of the reasoning paths and phases described above as exemplified in APPENDIX C for the snapshot. And, responsive to the query, the system 1 returns the following response to user 5_{b}:
“The Ground Station has the following types of ports:
Data Port: 1
Serial Port: 2
USB: 2
SMA Connector: 2
Ethernet: 3
N Connector: 8”

The system and process described herein provides numerous benefits and technical improvements over any existing solutions. The present embodiments enabled schema exploitation without schema discovery. This eliminates computational overhead of real-time schema introspection by leveraging pre-existing domain knowledge about model structure patterns. And enables complex graph traversals without requiring LLMs to understand graph theory or query languages. The hybrid semantic-structural approach combines benefits of semantic similarity (finding relevant content) with structural precision (accurate relationship traversal). The vector search handles entity disambiguation and semantic matching and the template queries ensure precise and efficient structural navigation. The embodiments enable scalable domain model integration. Generic schema mapping enables system extension to multiple domain model types. The template library can be expanded without modifying core processing logic and vector embeddings automatically adapt to new domain vocabulary and concepts. Finally, the embodiments reduce LLM cognitive load. The LLMs focus on intent recognition and parameter mapping rather than query construction. Pre-built templates eliminate syntax errors and optimize performance, while domain context reduces ambiguity in natural language interpretation.

The system processes domain models containing thousands of interconnected components (e.g., 2,034 nodes with 1,536-dimensional embeddings), maintains sub-second query response times, and supports concurrent multi-user access. Vector indices use cosine similarity with configurable result limits, while template queries support parameterized relationship traversals including variable-depth pattern matching.

The system is scalable. New domain model types may be integrated through schema mapping extensions. Query capabilities may be expanded through template library growth/System performance scales with vector index efficiency rather than schema complexity. And domain experts can contribute query templates without requiring graph database expertise.

Accordingly, FUSE-AI offers the ability to see and interact with all content within a graph (including the high-level structural entities, but also the lower level ones), and the ability to dynamically formulate new queries and responses incorporating that information, without requiring all of the information to be explicitly integrated into the schema itself, through the application of LLMs.

FUSE-AI increases accessibility to systems engineering models by offering human-readable descriptions of various aspects of the model under consideration, and reduces the need for additional domain expertise by integrating an AI tool. Any user, regardless of systems engineering experience, can ask questions of the system using natural language and learn about the state and execution of the model and use it as a reference.

In a particular exemplary implementation, this lightweight application has been developed and implemented on a MacBook Pro M1 and does not require graphics processing unit (GPU) support. User prompts are interpreted by LLM 40 (a non-limiting example of a publicly available LLM being Microsoft Azure ChatGPT 4 Turbo endpoint), and responses are generated using the same LLM 40. Alternatively, a localized (or private) LLM may be used, which would require GPU support. FUSE-AI provides a secure, localized, and light-weight application that can be deployed on Windows, Linux, or MacOS systems.

The following are exemplary use cases wherein the FUSE-AI system and process described herein would be beneficial.

Customer has many System Models (e.g., in modeler platforms such as Cameo, MagicDraw, Rhapsody, etc.), but not enough trained staff to interpret/reference them efficiently. The process herein ingests the SysML models, translates it to KG, and facilitates using an LLM to generate requirements and answer questions related to the referenced models to increase productivity and decrease response times.

Customer has many System Models (e.g., in modeler platforms such as Cameo, MagicDraw, Rhapsody, etc.), but is not trained in model interpretation. FUSE-AI facilitates model understanding by allowing them to ask questions about the model and its contents and receive natural language responses, decreasing the need for direct customer training on model utilization.

Customer has a complex SysML Model of a physical or digital system, and wants to analyze their model to identify hidden dependencies. FUSE-AI can be leveraged to permit use of advanced graph machine learning and analysis techniques, such as clustering and community detection, to reveal underlying relationships between components, providing enhanced insights and more robust decision-making for managing complex real-world systems.

It is to be understood that the novel concepts described and illustrated herein may assume various alternative configurations, except where expressly specified to the contrary. It is also to be understood that the specific systems, devices and processes illustrated in the attached drawings, and described herein, are simply exemplary embodiments of the embodied concepts defined in the appended claims.

The following documents are part of the existing art and knowledge thereof by those skilled in the art is assumed for purposes of supporting enablement and written description of the present embodiments. The documents are incorporated herein by reference in their entireties: S. Pan, L. Luo, Y. Wang, C. Chen, J. Wang, and X. Wu, “Unifying Large Language Models and KGs: A Roadmap,” arXiv:2306.08302v3 [cs. CL] 25 Jan. 2024; F. Schummer and M. Hyba, ‘An Approach for System Analysis with MBSE and Graph Data Engineering’, arXiv:2201.06363v1 [cs. SE] 17 Jan. 2022; and Shekhar, LangChain: A Complete Guide & Tutorial, Nanonets Blog (Nov. 15, 2023).

1. A process for facilitating interrogation of system engineering models comprising:
translating, by a processing system, a system engineering model representing a specific system in a first format into one or more Knowledge Graphs (KG) having a second format; and
translating, by the processing system, the one or more KGs from the second format into a third format, wherein the third format is a graph schema;
populating a graph database, by the processing system, with the graph schema representation of the system engineering model;
receiving, by the processing system, a text query of the graph database by a user;
retrieving, by the processing system, the graph schema from the graph database;
passing, by the processing system, the user's text query and the response from the graph scheme to a first large language model (LLM);
formulating, by the first LLM, a graph database query from the user's text query and the graph schema;
querying the graph database, by the processing system, with the graph database query;
receiving, by the processing system, a response to the graph database query from the graph database;
passing, by the processing system, the user's text query and the response from the graph database to a second large language model (LLM);
generating, by the second LLM, a text-based response to the user's text query; and
providing, by the processing system, the text-based response to the user.

2. The process of claim 1, wherein the first format is a system modeling language format and the second format is a graph composed of triples.

3. The process of claim 1, wherein the user's text query and the text-based response are in a natural language format and the graph database query and response to the graph database query are in a graph query language format.

4. The process of claim 3, wherein the graph query language format is Cypher.

5. The process of claim 1, wherein the first and second LLM are the same LLM.

6. The process of claim 1, wherein the first and second LLM are different LLMs.

7. The process of claim 1, wherein the specific system is selected from the group consisting of an aerospace system, a defense system, a railway, an automotive system, and manufacturing system.
